(19) United States
(12) Patent Application Publication
(10) Pub. No.: US 2019/0280863 A1
(43) Pub. Date: Sep. 12, 2019

(54) RECOVERY OF SECRET DATA IN A DISTRIBUTED SYSTEM

(71) Applicant: BizOne Ltd., Majuro (MH)

(72) Inventors: Frédéric Meyer, Nimes (FR); Jason Alan Cooper, Chesapeake, VA (US)

(21) Appl. No.: 16/294,804

(22) Filed: Mar. 6, 2019

Related U.S. Application Data
(60) Provisional application No. 62/639,210, filed on Mar. 6, 2018.

(51) Int. Cl. H04L 9/08; H04L 9/06; H04L 9/30; G06F 7/08; H04L 9/32

(52) U.S. Cl. CPC H04L 9/0894; H04L 9/085; H04L 9/0643; H04L 9/3271; H04L 9/30; G06F 7/08; H04L 9/0869

(57) ABSTRACT

Secret data is maintained as a plurality of secret shares distributed among a plurality of system nodes. When seeking to recover the secret data, a user node sends a request comprising a seed value to the system nodes. The user node receives, from each system node of at least a first subset of the plurality of nodes, a cryptographic hash value based on the seed value and information unique to the system node. The user node then generates an ordered listing of the first subset of the plurality of system nodes according to the corresponding plurality of cryptographic hash values. The user nodes selects a second subset of system nodes from the first subset based on the ordered listing. The user node then reconstructs the secret data based on the secret shares possessed by at least some of the second subset of the plurality of system nodes.

### CROSS-REFERENCE TO RELATED APPLICATION

The instant application claims the benefit of co-pending Provisional U.S. Patent Application Ser. No. 62/639,210 entitled “HARDWARE WALLET SYSTEM WITH SEED KEY RECOVERY” and filed Mar. 6, 2018, the teachings of which are incorporated herein by this reference.

### FIELD

The instant disclosure relates generally to distributed systems and secret sharing schemes within such systems and, in particular, to the recovery of secret data within such distributed systems.

### BACKGROUND

The use of distributed systems for the decentralized maintenance of data has been increasing recently. For example, so-called cryptocurrency systems rely on a distributed ledger that is cryptographically secured to maintain records of accounts. While these systems have proven viable, shortcomings include the need to securely store a password or the like in order to access and control funds maintained within the cryptocurrency system. Virtually all cryptocurrency systems warn users that loss of the required password will result in that user being unable to access his/her funds, essentially resulting in an irreversible loss of funds. Indeed, popular media is replete with stories of desperate investors unable to recall passwords.

Of course, the problem of lost passwords or other secret data is not restricted to cryptocurrency systems. Indeed, secret data can take many forms and is likewise not restricted to what might be strictly considered “passwords.” Another prominent example is encryption keys that, as known in the art, are used in cryptographic processes to mathematically transform data into an unrecognizable format, which mathematical transforms are ideally very difficult to reverse without knowledge of the encryption key. Again, an inability to produce or otherwise remember a necessary encryption key may prevent decryption of the encrypted data, which results in an effective loss of the data.

Various schemes for protecting secret data such as passwords and encryption keys are known in the art. For example, password managers are software programs (or hardware devices) that permit users to securely store secret data such as passwords in an encrypted fashion. Security of the encrypted data is often controlled by yet another master password that is itself susceptible to loss. That is, if a user of a password manager forgets or otherwise loses the master password, the secret data maintained in the password manager may be impossible to recover. Further, by maintaining the secret data in a centralized way, the security of any given portion of the secret data is only as good as security provided by the password manager program.

Other systems allow users to recover passwords through the use of so-called knowledge-based authentication (KBA). For example, such systems are often used by financial service institutions, email systems, etc. as a way of confirming identity of a user when that user needs to reset a forgotten password. In KBA systems, the user is presented with one or more questions or challenges that, at least theoretically, should be answerable only by that user. While KBA systems provide some assurance of identity, and therefore provide a way to minimize fraudulent access to secret data, such systems are nevertheless susceptible to attack. Additionally, security of KBA systems is impacted to the extent that such systems are often implemented in a centralized manner, such that hackers may gain access to the privileged questions and answers thereby rendering the KBA system ineffective.

Thus, it would be advantageous to provide techniques that permit the recovery of secret data without the shortcomings of prior art solutions.

### SUMMARY

The instant disclosure describes techniques for recovering secret data in distributed, secret sharing systems. In an embodiment, a distributed system comprises a user node and a plurality of systems nodes. Secret data is maintained as a plurality of secret shares distributed among the plurality of system nodes, such that knowledge of less than a first threshold number of the plurality of secret shares is insufficient to reconstruct the secret data. When seeking to recover the secret data, the user node sends a request comprising a seed value to the plurality of system nodes. In an embodiment, the seed value is a random value generated by the user node. Thereafter, the user node receives, from each system node of at least a first subset of the plurality of nodes and in response to the request, a cryptographic hash value based on the seed value and information unique to the system node, thereby providing a plurality of cryptographic hash values uniquely corresponding to the first subset of the plurality of system nodes. The information unique to the system node may comprise a public key for that system node. The user node then generates an ordered listing of the first subset of the plurality of system nodes according to the corresponding plurality of cryptographic hash values. As a non-limiting example, such ordering may be accomplished by sorting the plurality of cryptographic hash values in ascending or descending order. The user nodes selects a second subset of system nodes from the first subset based on the ordered listing. The user node then reconstructs the secret data based on the secret shares possessed by at least some of the second subset of the plurality of system nodes. Given the stochastic nature of the seed value and the resulting cryptographic hash values, the order of the system nodes within the ordered listing is extremely difficult to predict and consequently, the identity of the particular system nodes included in the second subset used to obtain the secret shares is likewise extremely difficult to predict.

In an embodiment, the user node receives a rate limiting challenge from a system node of the plurality of system nodes, which rate limiting challenge comprises parameters for performing a computation by the user node and a required result to be determined through performance of the computation. The user node performs the computation based on the parameters and a user-node-determined value until the required result is achieved. Thereafter, the user node sends the required result to the system node.

In another embodiment, the user node obtains the secret shares possessed by the second subset of the plurality of system nodes based on at least one identity verification challenge provided by the second subset of the plurality of system nodes. In this embodiment, the user node sends a request to receive at least one identity verification challenge from the second subset of the plurality of system nodes and, in response to that request, receives the at least one identity verification challenge. Each of the at least one identity verification challenge requires performance by a user of the user node to provide at least one response to the at least one identity verification challenge and thereafter sending, by the user node, the at least one response to the second subset of the plurality of system nodes. Thereafter, the user node receives at least some of the plurality of secret shares to provide received secret shares from at least some of the second subset of the plurality of system nodes, and the user node then reconstructs the secret data based on the received secret shares when a total number of received secret shares equals or exceeds the first threshold number.

In another embodiment, the user node obtains the at least one identity verification challenge based on challenge configuration data provided by the second subset of the plurality of system nodes. In this embodiment, the user node sends a request to receive challenge configuration data from the second subset of the plurality of system nodes, where the challenge configuration data is distributed as a plurality of challenge configuration shares among the plurality of system nodes and where knowledge of less than a second threshold number of the plurality of challenge configuration shares is insufficient to reconstruct the challenge configuration data. Responsive to the request, the user node receives at least some of the plurality of challenge configuration shares from at least some of the second subset of the plurality of system nodes to provide received challenge configuration shares. Thereafter, the user node reconstructs the challenge configuration data based on the received challenge configuration shares when a total number of received challenge configuration shares equals or exceeds the second threshold number. A request by the user node to receive the at least one challenge may be based on the reconstructed challenge configuration data.

In yet another embodiment, the user node obtains the challenge configuration data based on configuration prekey data provided by the second subset of the plurality of system nodes. In this embodiment, the user node sends a request to receive configuration prekey data from the second subset of the plurality of system nodes, where the configuration prekey data is distributed as a plurality of configuration prekey shares among the plurality of system nodes and where knowledge of less than a third threshold number of the plurality of configuration prekey shares is insufficient to reconstruct the configuration prekey data. Responsive to the request, the user node receives at least some of the plurality of configuration prekey shares from at least some of the second subset of the plurality of system nodes to provide received configuration prekey shares. Thereafter, the user node reconstructs the configuration prekey data based on the received configuration prekey shares when a total number of received configuration prekey shares equals or exceeds the third threshold number. A request by the user node to receive the at least one challenge configuration data may be based on the reconstructed configuration prekey data.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is a block diagram of a distributed, shared secret system in accordance with an embodiment of the instant disclosure;

FIG. 2 is a block diagram of a computing device that may be used to implement user nodes and/or system nodes in accordance with an embodiment of the instant disclosure;

FIG. 3 is a flow chart illustrating processing performed by a user node for the recovery of secret data in accordance with an embodiment of the instant disclosure; and

FIGS. 4A and 4B illustrate an example of processing within a distributed system for the recovery of secret data in accordance with an embodiment of the instant disclosure.

### DETAILED DESCRIPTION OF THE PRESENT EMBODIMENTS

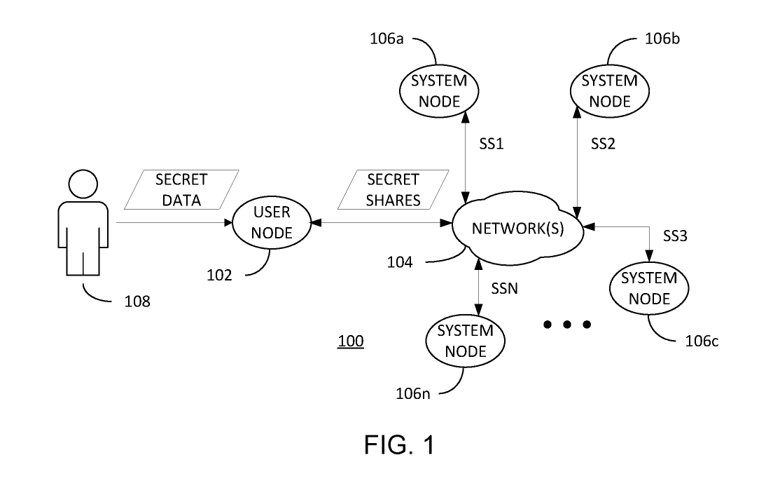

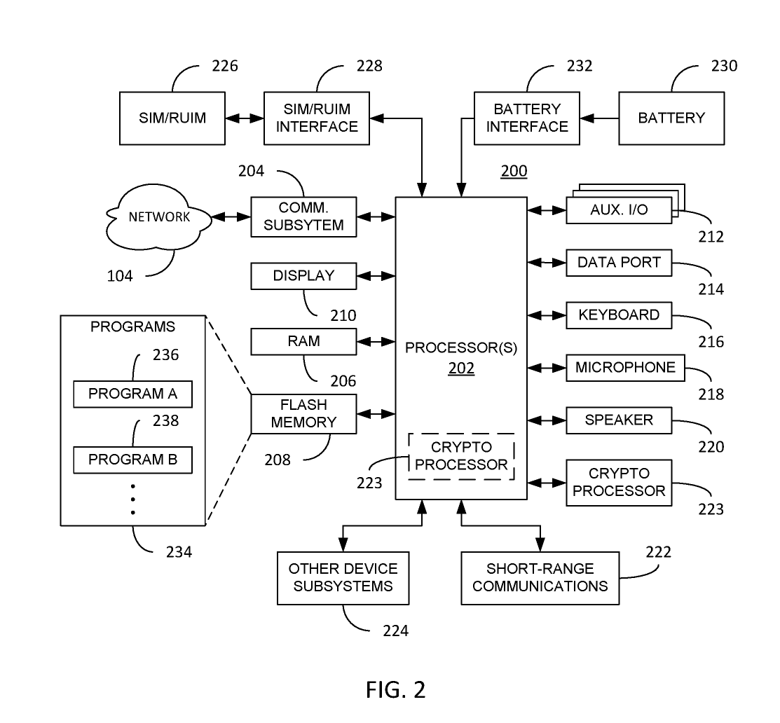

FIG. 1 illustrates a block diagram of a distributed system 100 comprising a user node 102 and a plurality of system nodes 106a-n. Each of the nodes 102, 106a-n may comprise a computing device of the type illustrated in FIG. 2 and described in further detail below. A user 108 may operate and interact with the user node 102 as described in further detail below. In an embodiment, the user node 102 and the system nodes 106a-n are capable of communicating with each other through one or more networks 104. In an embodiment, the networks may comprise a public network (e.g., the Internet, World Wide Web, etc.), a private network (e.g., local area network (LAN), etc.) or combinations thereof (e.g., a virtual private network, LAN connected to the Internet, etc.). Furthermore, the network 104 need not be a wired network only, and may comprise wireless network elements as known in the art. The number of system nodes 106a-n included in the system 100 may be selected as a matter of design choice and may be in the range from a single node to plurality of nodes potentially filling currently known address spaces such as IPv6.

As noted, the user node 102 is a computing device representing the user 108 in the digital domain. In the context of the instant disclosure, the purpose of the user node 102 is generally to secure secrets, and ensure they are used only in a manner authorized by the user 108. Although a single user node 102 is shown in FIG. 1 for ease of illustration, those skilled in the art will appreciate that any number of user nodes (representative of a corresponding number of users) may be incorporated into the system 100 in accordance with known communication technologies.

In an embodiment of the instant disclosure, secret data may be provided by the user 108 to the user node 102. The secret data may also be generated by user node 102 for user 108. As described above, the secret data may comprise any digitally represented data such as a password, encryption key, container of one or more secrets, etc. In many situations, the secret data is comparatively small (on the order of a few kilobytes or tens of kilobytes), though the instant disclosure is not limited in this regard. As illustrated in FIG. 1, the user node 102 may operate to transform the secret data into a plurality of secret shares (SS1, SS2, SS3, SSN) that are then distributed to the plurality of system nodes 106a-n. Various techniques for such transformations are well-known in the art. A presently preferred technique for implementing the transformation of secret data into secret shares is the well-know Shamir's Secret Sharing Scheme (SSSS). A favorable property of SSSS, unlike other secret sharing (or splitting) schemes, is that the scheme can be implemented such that less than the total number of secret shares distributed throughout the system may be employed to reconstruct the secret. On the other hand, no less than a threshold number of secret shares is required to reconstruct the secret; thus, knowledge of some number of secret shares less than the threshold number will be insufficient to reconstruct the secret.

Referring now to FIG. 2, an example configuration for a computing device 200 (that may be used to implement the user node 102 and system nodes 106a-n of FIG. 1) is illustrated in block diagram form. The illustrated computing device 200 includes components suitable for making the computing device 200 mobile. However, those having skill in the art will appreciate that this is not a requirement and that the computing device 200 may not include all of the components illustrated in FIG. 2, or may include known components not illustrated in FIG. 2.

Regardless, the computing device 200 comprises a number of components such as one or more processors 202 (e.g., microprocessors, microcontrollers, digital signals processors, co-processors or the like) that control the overall operation of the computing device 200. Communication functions, including data and voice communications, are performed through a communication subsystem 204. The communication subsystem 204 implements various communication protocols that allow it to receive messages from and send messages to the network 104. For example, in the case that the computing device 200 is a mobile device, the communication subsystem 204 may be configured in accordance with the well-known GSM (Global System for Mobile Communications) and GPRS (General Packet Radio Service) standards. Other communication configurations that are equally applicable include the so-called 3G and 4G telecommunication networks known in the art. As will be appreciated by those of skill in the art, new standards are still being defined that are likely to have functional similarities to the network behavior described herein, and it is understood that the embodiments described herein are intended to use any other suitable standards that are developed in the future. The link connecting the communication subsystem 204 with the network 104 may represent, again in the case of a mobile device, one or more different Radio Frequency (RF) channels, operating according to defined protocols specified for GSM/GPRS communications. Alternatively, or additionally, the communication subsystem 204 may implement communication protocols suitable for communicating through wired networks (as opposed to wireless) networks as known in the art.

The one or more processors 202 also interact with additional subsystems such as a Random Access Memory (RAM) 206, a flash memory 208, a display 210, an auxiliary input/output (I/O) subsystem 212, a data port 214, a keyboard 216, a speaker 220, a microphone 218, short-range communications 222, and other device subsystems 224. The short-range communications 222 can implement any suitable or desirable device-to-device or peer-to-peer communications protocol capable of communicating at a relatively short range, e.g. directly from one device to another. Examples include “BLUETOOTH”, ad-hoc WiFi, infrared, or any “long-range” protocol re-configured to utilize available short-range components. It will therefore be appreciated that short-range communications 222 may represent any hardware, software or combination of both that enable a communication protocol to be implemented between devices or entities in a short range scenario, such protocol being standard or proprietary. An example of an additional device subsystem 224 includes a camera subsystem that may be used to capture images including, but not limited to, bar codes or QR codes that may be decoded using known processing techniques.

Some of the subsystems of the computing device 200 perform communication-related functions, whereas other subsystems may provide “resident” or on-device functions. By way of example, the display 210 and the keyboard 216 may be used for both communication-related functions, such as entering secret data for transformation into secret shares and subsequent transmission over the network 104, and device-resident functions such cryptographic processing as described below.

The computing device 200 can send and receive communication signals over the network 104 after required network registration or activation procedures have been completed. Network access is associated with a subscriber or user of the computing device 200. To identify a user, the computing device 200 may use a subscriber module component or “smart card” 226, such as a Subscriber Identity Module (SIM), a Removable User Identity Module (RUIM) and a Universal Subscriber Identity Module (USIM). In the example shown, a SIM/RUIM/USIM 226 can be inserted into a SIM/RUIM/USIM interface 228 in order to communicate with a network. Without the component 226, the computing device 200 may not fully operational for communication with the network 104. Once the SIM/RUIM/USIM 226 is inserted into the SIM/RUIM/USIM interface 228, it is coupled to the one or more processors 202.

The computing device 200 may be a battery-powered device (and in this example includes a battery interface 232 for receiving one or more rechargeable batteries 230. The battery interface 232 is coupled to a regulator (not shown), which assists the battery 230 in providing power V+ to the computing device 200. Alternatively, the computing device 200 may be powered by mains electricity provided through conventional outlets, as known in the art.

In the examples described herein, the computing device 200 comprises or otherwise has access to a cryptographic processor or secure element 223 which can be embodied in hardware, software, or a combination of the two. As known in the art, the cryptographic processor 223 may control or include a software-based cryptographic module or application that cryptographically processes data. The computing device 200 may also comprise internal or external memory or other machine-readable media for storing executable instructions that may be executed by the processor(s) 202 including, but not limited to, enabling the cryptographic processor 223 to perform cryptographic operations as is known in the art. As can be seen in FIG. 2, the cryptographic processor 223 may be independent of the processor(s) 202 in a mobile device configuration for example, or may be implemented by special instructions or hardware associated with the one or more processors 202.

The computing device 200 may also optionally include an operating system 234 and a plurality of software components 236, 238. The operating system 234 and the software components 236, 238 that are executed by the at least one processor 202 are typically stored in a persistent or non-volatile store such as the flash memory 208, which may alternatively be a read-only memory (ROM) or similar storage element (not shown). Those skilled in the art will appreciate that portions of the operating system 234 and the software components 236, 238, such as specific device applications, or parts thereof, may be temporarily loaded into a volatile storage devices such as the RAM 206. Other software components can also be included, as is well known to those skilled in the art.

The data port 214 can be any suitable port that enables data communication between the computing device 200 and another computing device. The data port 214 can be a serial or a parallel port. In some instances, the data port 214 can be a USB (Universal Serial Bus) port that includes data lines for data transfer and a supply line that can provide a charging current to charge the battery 230 of the computing device 200.

For voice communications, received signals are output to the speaker 220, and signals for transmission are generated by the microphone 218. Although voice or audio signal output is accomplished primarily through the speaker 220, the display 210 can also be used to provide additional information such as the identity of a calling party, duration of a voice call, or other voice call related information.

For composing data inputs, a user or subscriber could use a touch-sensitive overlay (not shown) on the display 210 that is part of a touch screen display (not shown), in addition to possibly the auxiliary I/O subsystem 212. The auxiliary I/O subsystem 212 may include devices such as: a mouse, track ball, infrared fingerprint detector, or a roller wheel with dynamic button pressing capability.

As noted above, the software applications 236, 238 stored in flash memory 208 (or the like) may include a cryptographic module that comprises or otherwise has access to a portion of memory, database or other data storage device for the storage of any data or information associated with the cryptographic capabilities of various computing devices, as described in further detail below.

It will be appreciated that any module or component exemplified herein that executes instructions may include or otherwise have access to computer-readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing device 200 or accessible or connectable thereto. Any processing described herein may be implemented using computer readable/executable instructions that may be stored or otherwise held by such computer readable media.

In general, a system node 106a-n may be used for distributed processing associated with the storage of secret shares as well as processing (in conjunction with processing performed by the user node 102) required to facilitate user authentication during the recovery of secret data in accordance with the techniques described herein. That is, while it is possible for system nodes 106a-n to function both for distributed storage purposes as well as distributed verification purposes, it is presently preferred to separate those two functions between different types of system nodes. To this end, in an embodiment, system nodes may be distinguished as storage nodes and authenticator nodes. In this embodiment, storage nodes may comprise widely distributed key/value databases. Many deployments for such storage currently exist and may be leveraged for the techniques described herein. As used herein, the “key” in key/value pairs refers to an identifier akin to, for example, a Globally Unique Identifier (GUID) or other index, not to be confused with encryption keys. A requirement of storage nodes is that at any given time, it is able to produce an object for a given key/GUID, though it is permissible for storage nodes to be in and out of service as may be.

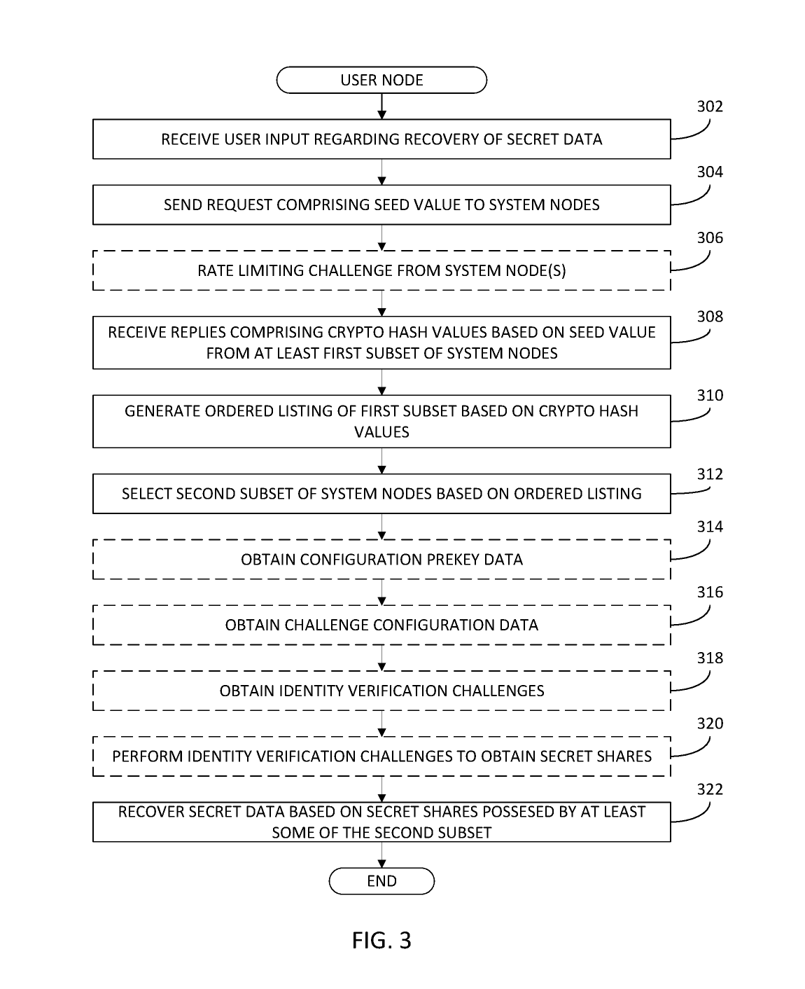

Authenticator nodes perform processing required to prove user identity during a recovery process as described in further detail below. Authenticator nodes, like storage nodes, can come and go as needed, as long as there are a sufficient number of them to each verify an individual piece of identity. For security purposes, it is assumed that one or more authenticator nodes may be malicious. This threat is mitigated by only trusting any single authenticator node with the absolute minimum of sensitive data. The chances of multiple malicious authenticator nodes colluding is mitigated through the process illustrated in FIG. 3.

Referring now to FIG. 3, a flow chart illustrates processing performed by a user node for the recovery of secret data in accordance with an embodiment of the instant disclosure. Such a recovery procedure may be required, for example, in the case where a user needs access to the secret data that is otherwise distributed throughout a system as secret shares, but is unable to produce credentials normally used to access the secret shares that would permit reconstruction of the secret data. The description relative to FIG. 3 below makes reference to system nodes, which as described above, are understood in this embodiment to be capable of storage and/or authentication functionality as required.

Thus, beginning at block 302, the user node receives input from a user of the user node indicating that the user would like to initiate recovery of the secret data. Such inputs may be provided, for example, via a menu selection in a graphical user interface implemented by the user node or through similarly known input mechanisms. In an embodiment described in greater detail below, at the very least, the user is required to input personally identifying information (PII) that is used to initiate the recovery process. For example, such PII may comprise the user's family name, the user's given name, the user's date of birth and the user's place of birth. Those skilled in the art will appreciate that other types of PII may be equally used for this purpose. Additionally, though it is not required, it would be desirable if the user is also required to provide a passphrase to initiate the recovery process. Again, when the passphrase or similar credential is provided, it is used to initiate the recovery process.

Regardless, having received the user's indication that the recovery process should be initiated, processing proceeds to block 304 where the user node sends a request to the plurality of system nodes. In an embodiment, the request includes a seed value, which may comprise a random number generated by the user node using a properly seeded, cryptographically secure pseudo random number generator (CS-PRNG), as known in the art. For example, the seed may comprise a random number that is 256-bits in length. Further, the seed may be deterministically generated from data that is outside the control of the user or user node, e.g., where a blockchain is maintained to preserve information regarding use of the system, a cryptographic hash of the latest consensus block of the blockchain could be employed for this purpose.

In response, the user node, at block 308, receives a cryptographic hash value based on the seed value from each system node of at least a first subset of the plurality of system nodes. The first subset may be less than or equal to the total number of system nodes included in the plurality of system nodes. For example, less than the total number of system nodes may respond to a given request due to being in an inactive state (e.g., powered down or disconnected from the network 104). In a presently preferred embodiment, the cryptographic hash value, h, may be a hash-based message authentication code (HMAC), as known in the art, generated according to:

h=HMAC(seed,NodePubKey) (1)

where NodePubKey is a public key corresponding to a given system node. However, it is not a requirement that a public key be used for this purpose. In generally, any data that is uniquely associated with the given system node may be used. Additionally, the HMAC may be computed over other data uniquely associated with the system node. For example, where each of the system nodes is itself authenticated using a public key infrastructure (PKI), the HMAC may be calculated over concatenation of a given system node's PKI certificate and its public key. Thereafter, the system node may compute its reply to the request as a concatenation (∥) of the data used to compute the cryptographic hash value along with the cryptographic hash value itself. From the example above, this would result in:

Reply=(seed∥NodePubKey∥h) (2)

To verify the reply, the given system node may also provide a signature, s_{node}, along with its reply:

s_{node}=SIGN(NodePrivKey,Reply) (3)

where, in this example, SIGN is the digital signature function based on the system node's private key, NodePrivKey. To the extent that each system node in the first subset has provided a cryptographic hash value based on its associated parameters, the user node will have a plurality of cryptographic hash values uniquely corresponding to the first subset of system nodes.

As noted above relative to block 302, it is possible to perform the process illustrated in FIG. 3 without the requesting user entering a passphrase or similar credential. When such a passphrase is not provided, however, the recovery process described herein could be susceptible to a brute force attack in which an adversary submits numerous requests of the type described above. A process to mitigate such susceptibility is to rate limit the requests that a user node can submit, as illustrated by optional block 306. As known in the art, rate limiting schemes may be implemented through a “proof of work” to be performed by the requesting entity (the user node) as required by the responding entity (a given system node). In an embodiment described herein, the rate limiting challenges are designed such that the responding entity does not need to retain state between responding with the rate limiting challenge and receiving the required result from the requesting entity. Depending on network configuration, these could be several minutes to even hours apart.

In this particular embodiment, the rate limiting challenge comprises parameters for the requesting entity to use in performing a computation to provide the required result. For example, let RL_seed be a random number generated on a long term interval (e.g. 1 hour or 1 day) by a properly seeded, CS-PRNG. Let Salt be a per-request, randomly generated number, and let cookie be a deterministically generated random number which is sent to the requesting entity, where:

$$cookie = HKDF ( Seed , Salt , Request \vert \vert [ \frac{Epoch}{Period} ] ) \qquad ( 4 )$$

where Period is the validity window for a calculated cookie in seconds and Epoch is the current number of seconds that have passed since Jan. 1, 1970, UTC. Alternatively, the quotient Epoch/Period could be replaced by a non-temporal, though still time-varying, value. For example, once again, where a blockchain is used to record and preserve system usage, this quotient could be replaced by a value calculated according to REDUCE(HASH(latest_consensus)), where latest_consensus is the most recent consensus block in the blockchain, HASH is any appropriate cryptographic hashing function and REDUCE is a length reduction function such that the calculated cookie is invariant until the next consensus block of the blockchain is produced.

Calculated in this manner, the cookie permits the responding entity to quickly ascertain the freshness of a cookie without having to maintain a list of issued cookies. Regardless, once computed, the responding entity sends the cookie and Salt to the requesting entity as part of a rate limiting challenge message. This challenge message also includes the required proof of work factor. The proof of work factor is a series of parameters, identifying the hash to use, its size, and the leading number of zeros required to complete the task.

Upon receiving this rate limiting challenge message from the responding entity, the requesting entity must complete the proof of work according to:

wiggle=CS_PRNG( ) (5)

response=HASH(wiggle∥cookie) (6)

where the requesting entity uses the hash and hash size identified in the parameters of the message to implement the HASH. The requesting entity checks response to see if it meets the factor criteria for number of leading zeros indicated in the parameters, where the number of leading zeros is counted across the binary form of response. For example, a factor of eight leading zeros can be satisfied if the eight most-significant-bits of the response are all zero.

If the calculated response doesn't meet the factor criteria for number of leading zeros, the requesting entity changes the wiggle in any desired manner and calculates a new response. This second response is tested against the same criteria for leading zeros and, if it fails, the requesting entity repeats the calculation with yet another wiggle. The requesting entity continues this loop until a passing response is found. This is the rate-limiting “work” in “proof of work.”

Once a suitable response is found, the requesting entity sends the cookie, salt, wiggle, and response with the request to the responding entity.

The act of checking the freshness of the cookie is implemented in the validity period calculation. By simply using the current elapsed seconds since epoch in the Epoch field, the integer division by Period will only produce the same value for cookie for a period of time no greater than the number of seconds designated by Period. Alternatively, in the case of the hashed and reduced blockchain consensus block noted above, the same cookie value will be produced provided that, in the interim, no new consensus block has been computed in the blockchain.

The responding entity verifies the freshness of the submitted answer by re-calculating cookie, using Eq. (4), with the current elapsed time since epoch for Epoch. If the result matches the cookie in the submitted response, then the responding entity shall proceed. If the cookie does not match, the responding entity silently drops the message.

With the freshness established, the proof of work must be verified before the requesting entity's request can be fulfilled. In order to check the validity of the proof of work, the responding entity uses the values in the submitted answer and performs the calculation as in Eq. (6). If, and only if, the responding entity calculates the same response as that provided by the requesting entity, then the request is considered valid and the responding entity may process the request and send the result to the requesting entity. If the response doesn't match, the message is silently dropped.

In order to prevent undue latencies in the system, it is appreciated that rate limiting challenges cannot be employed every time a user node submits a request to a system node. To balance the need for security with the need for process efficiency, the user node can, at the beginning of the recovery process session, but prior to successful completion of any rate limiting challenge, create an ephemeral keypair. Techniques for the creation of such ephemeral keypairs are well-known to those having skill in the art. For example, such ephemeral keypairs may take the form of a public/private keypair. In this case, then, the user node signs each message it sends with the private key from that key pair, and provides the public key for verification. In this manner, system nodes can then ensure that only subsequent requests from that user node employing the required ephemeral keypair are permitted. Optionally, a blockchain may be used to register the user node request and public key. This would permit system nodes to verify the subsequent messages against a decentralized registry.

Referring once again to FIG. 3, regardless whether a rate limiting challenge is employed at block 306, processing continues at block 310, where the user node generates an ordered listing of the first subset of the plurality of system nodes according to the corresponding plurality of cryptographic hash values. In practice, the ordered listing may be the result of any desired sorting applied to the plurality of cryptographic hash values, i.e., ascending or descending. Under this scheme, the random nature of the cryptographic hash values ensures that the ordering of the first subset of system nodes in the ordered listing will be random, thereby minimizing any chance that one or more malicious system nodes may attempt to increase the likelihood that they will be chosen to perform authentication processing for a given user node. However, those having skill in the art will appreciate that still other sorting techniques may be employed to provide the ordered listing. For example, if a blockchain is maintained and the cryptographic hash values are recorded to blockchain as individual transactions, then the cryptographic hash values may be sorted according to order in which they were recorded to the blockchain.

Thereafter, processing proceeds to block 312 where the user node selects, based on the ordered listing, a second subset of system nodes from within the first subset of system nodes. For example, Let S be the number system nodes in the first subset. Let A be the number of desired candidate nodes to be chosen at block 312. The sorted cryptographic hash values are indexed, starting at 0. Let w be a positive integer within [1; A], such that if w=1, the index, i, of the first selected cryptographic hash value can be calculated according to:

$$i = [ \frac{wS}{A + 1} ] \qquad ( 7 )$$

In an embodiment, a sufficient number of cryptographic hash results, S, are required such that, for a given A:

S≥10A (8)

where it is understood that the ratio established by Eq. (8) may be modified as a matter of design choice.

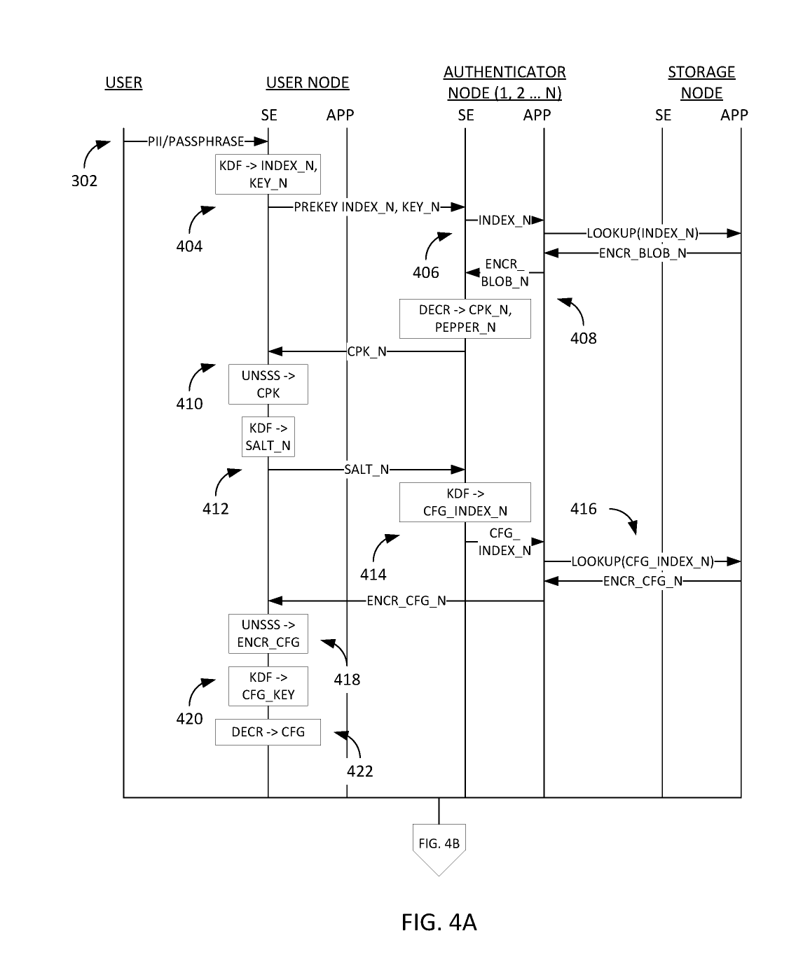

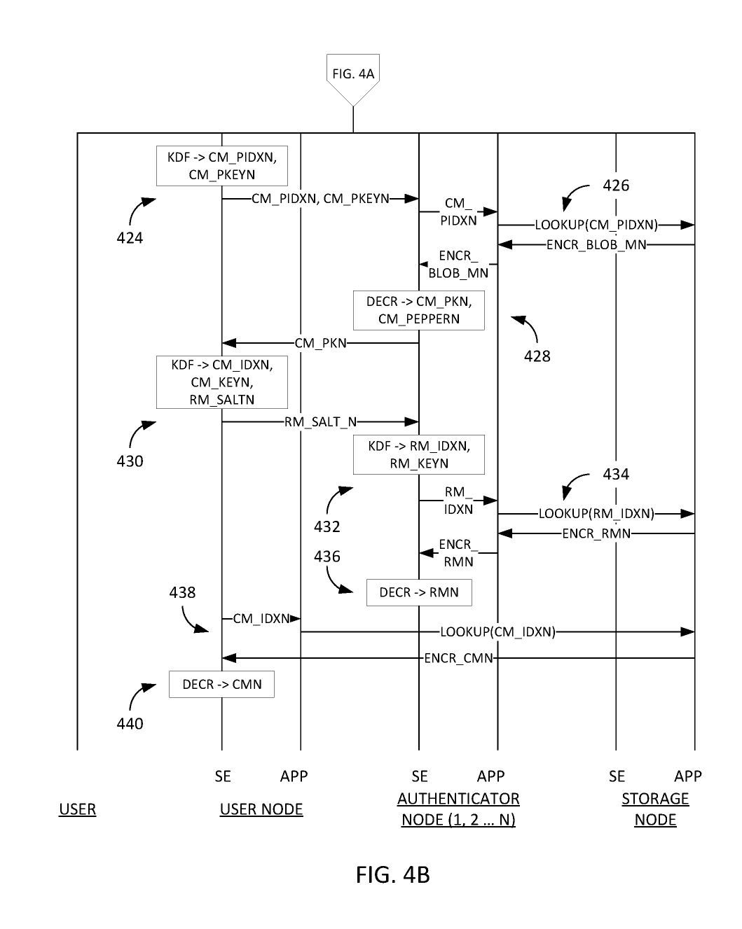

Having selected a second subset of system nodes, it is now possible for the user node to obtain the secret shares from the system nodes included in the second subset, and thereby recover the secret data by reversing the secret sharing scheme at block 322. In the context of SSSS, the known process of reconstructing the secret data may be referred to as “UnSSSS.” The process of obtaining the secret shares and reconstructing the secret data may be safely performed without any further authentication of the requesting user in the case where the user presented a passphrase or similar credential at block 302. However, as noted above, the instant techniques may nevertheless permit recovery of the secret information even in those instances where no passphrase or similar credential is provided at block 302, or where a level of security beyond passphrase/credential presentation is desired. To this end, as illustrated by optional blocks 314-320, an embodiment is provided in which secret shares may be obtained only when the user node is able to retrieve and correctly answer one or more identity verification challenges, which challenges may be obtained only if a process of obtaining configuration prekey data and challenge configuration data is successfully performed. This embodiment is further described below with reference to FIGS. 4A and 4B.

FIGS. 4A and 4B illustrate processing performed by a user node and system nodes in an embodiment in which identity verification challenges are used to authenticate a user. In the embodiment of FIGS. 4A and 4B, the use of authentication nodes and storage nodes, as described above, is illustrated. As further shown, each of the user, authentication and storage nodes includes a cryptographic processor or secure element (SE) used to perform any required cryptographic processing, and an application (APP) used to perform any non-cryptographic processing as needed. In this embodiment, processing begins at step 302 where, as in FIG. 3, the user provides PII and, optionally, a passphrase to the user node. Regardless, processing moves to step 404 where the secure element of the user node implements a key derivation function (KDF) to derive, for each of the authentication nodes included in the second subset (as described above), a prekey index (prekey_index_n) and key (prekey_key_n). As known in the art, a KDF is a pseudo-random function that derives one or more encryption keys from other values. For example, in an embodiment, the well-known password-based key derivation function 2 (PBKDF2) function is used as follows:

prekey_index_n=PBKDF2(PII,“stage0_prekey_index_n”,Passphrase) (9)

prekey_key_n=PBKDF2(PII,“stage0_prekey_key_n”,Passphrase) (10)

where “stage0_prekey_index_n” and “stage0_prekey_key_n” are input strings for 0≤n≤N−1, where N is the number of authentication nodes in the second subset as described above. As shown throughout this disclosure, the various input strings provided to key derivation functions are understood to be non-limiting, for example purposes, and may be selected as a matter of design choice. As further noted above, the Passphrase is optional and may not be provided in all cases. The user node then sends prekey_index_0 and prekey_key_0 to the first chosen authenticator node in the second subset, the prekey_index_1 and prekey_key1 to the second chosen authenticator node in the second subset, and so on until all authenticator nodes have received the data needed to obtain the challenge configuration data.

At step 406, each authenticator node, N, then performs a query (LOOKUP) with a storage node based on the prekey_index_n, thereby retrieving encr_blob_n, i.e., encrypted data:

encr_blob_n=LOOKUP(prekey_index_n) (11)

Note that it is assumed that the encrypted data, encr_blob_n, was previously encrypted and stored via an encryption process based on the prekey_key_n. Consequently, at step 408, the secure element in each authentication node decrypts the encrypted data:

Blob_N=AEAD_decrypt(prekey_key_n,encr_blob_n) (12)

where AEAD_decrypt refers to the well-known authenticated encryption with additional data decryption process, and where Blob_N comprises a configuration prekey share (CPK_N) and a first random value (Pepper_N). Furthermore, while the instant disclosure makes repeated reference to AEAD_decrypt, it is understood that other suitable decryption techniques (and, by implication, corresponding encryption techniques used to store data in the system/storage nodes) may be equally employed. Regardless, thereafter, the authenticator node sends the configuration prekey share to the user node. The configuration prekey share, CPK_N, represents a secret share of a configuration prekey that is used, as described below, to obtain configuration data that may be used, in turn, to obtain one or more identity verification challenges. At step 410, the secure element of the user node performs UnSSSS on the configuration prekey shares that it has received from the second subset of authentication nodes to provide the configuration prekey (CPK):

CPK=UnSSSS(CPK_1,CPK_2 . . . CPK_N) (13)

With the configuration prekey thus in hand, the user node, at step 412 creates and sends a configuration salt, salt_n, for each of the authenticator nodes as follows:

salt_n=HKDF(CPK,“stage0_salt_n”,PII∥Passphrase) (14)

where “stage0_salt_n” are input strings for 0≤n≤N−1 and the passphrase is, once again, optional.

Upon each respective authenticator node receiving its corresponding configuration salt, salt_n, processing continues at step 414 where each authenticator node calculates a corresponding configuration index, cfg_index_n, according to:

cfg_index_n=HKDF(Pepper_N,“stage0_cfg_index”,salt_n) (15)

where “stage0_cfg_index” is an input string to the key derivation function. Having thus obtained its corresponding configuration index, cfg_index_n, each authentication node then performs a lookup from the storage node to provide an encrypted configuration share, encr_cfg_n, at step 416. The authenticator node then provides its encrypted configuration share to the user node that, at step 418, then reconstructs the encrypted configuration data, encr_cfg.

At step 420, the user node also obtains a configuration key, cfg_key, according to:

cfg_key=HKDF(CPK,“stage0_config_key”,PII∥Passphrase) (16)

where “stage0_config_key” is an input string to the key derivation function, and the passphrase is, once again, optional.

Having now obtained the encrypted configuration data, encr_cfg, and the configuration key, cfg_key, the user node then decrypts the encrypted configuration data at step 422 to provide the challenge configuration data, cfg:

cfg=AEAD_decrypt(cfg_key,encr_cfg) (17)

The configuration data, cfg, is a relatively small file comprising a header, and a series of challenge entries. To facilitate smooth handling of changes to the file format, the header preferably consists of at least a version number.

Let there be M identity authentication challenge entries in the configuration file. Each of the M entries comprises all the information necessary for the client node and authenticator nodes to retrieve, decrypt, and perform each challenge. As described above, each identity authentication challenge requires performance by the user to provide a response to the challenge. In an embodiment, such performance requires the user of the user node to either provide information that is likely only known to the actual user or to execute a task that only the actual user is likely able to execute. If an authenticator node determines that the response provided by the client node for a given challenge is correct, the authenticator node “votes” by releasing a secret share corresponding to the secret data maintained by the system. The process of retrieving a challenge shall be described once, for Entry M.

Each challenge entry will specify the number of authenticator nodes needed for that particular challenge. The user node performs the authenticator node selection process as described above relative to blocks 302-312 for each identity authentication challenge to obtain a new, second subset of authenticator nodes, as described above, just for that challenge. In so doing, it is acceptable for a single authenticator node to be chosen for more than one challenge, but not more than once per challenge.

Given the Mth challenge entry in the decrypted configuration file, the user node first calculates, at step 424 for each selected authenticator node, a prekey challenge index, cm_pidxn, and a prekey challenge key, cm_pkeyn, according to:

cm_pidxn=PBKDF2(PII,“stage1_prekey_index_n”,Passphrase) (18)

cm_pkeyn=PBKDF2(PII,“stage1_prekey_key_n”,Passphrase) (19)

where “stage1_prekey_index_n” and “stage0_prekey_key_n” are input strings for 0≤n≤N−1, where N is the number of authentication nodes in the second subset as described above. Once again, the passphrase is optional. The user node provides the prekey challenge index and prekey challenge key to the corresponding authenticator node.

Thereafter, at step 426, each authenticator node then performs a query (LOOKUP) with a storage node based on the prekey challenge index, thereby retrieving encr_blob_mn, i.e., encrypted data for the challenge:

encr_blob_mn=LOOKUP(cm_pidxn) (20)

Note that it is assumed that the encrypted data, encr_blob_mn, was previously encrypted and stored via an encryption process based on the prekey challenge key. Consequently, at step 428, the secure element in each authentication node decrypts the encrypted data:

Blob_MN=AEAD_decrypt(cm_pkeyn,encr_blob_mn) (21)

where Blob_MN comprises a prekey for challenge M (cm_pkn) and a first random value for challenge M (CM_PepperN). Thereafter, the authenticator node sends the prekey for challenge M to the user node.

At step 430, the user node performs the follow operations, for each authenticator node, to provide an index for challenge M, cm_idxn, a key for challenge M, cm_keyn, and a response salt, rm_saltn, according to:

cm_idxn=PBKDF2(PII,“stage1_challenge_index”,cm_pkn∥passphrase) (22)

cm_keyn=PBKDF2(PII,“stage1_challenge_key”,cm_pkn∥passphrase) (23)

rm_saltn=PBKDF2(PII,“stage1_response_salt”,cm_pkn∥passphrase) (24)

where “stage1_challenge_index,” “stage1_challenge_key,” and “stage1_response_salt” are input strings to the key derivation function, and where the passphrase is, once again, optional. The user node then passes the response salt to its corresponding authenticator node. In turn, each authenticator node derives, at step 432, a response index for challenge M, rm_idxn, and a response key for challenge M, rm_keyn, according to:

rm_idxn=HKDF(CM_PepperN,“stage1_response_index”,rm_saltn) (25)

rm_keyn=HKDF(CM_PepperN,“stage1_response_key”,rm_saltn) (26)

Thereafter, each authenticator node, at step 434, uses the response index for challenge M to retrieve encrypted data for the response to challenge M, encr_rmn, as follows:

encr_rmn=LOOKUP(rm_idxn) (27)

and each authenticator node subsequently decrypts the encrypted data for the response to challenge M, at step 436, to provide the decrypted response for challenge M, RMN, as follows:

RMN=AEAD_dectypt(rm_keyn,encr_rmn) (28)

In parallel (though illustrated as occurring after step 436), the user node retrieves the encrypted challenges, encr_cmn, at step 438 according to:

encr_cmn=LOOKUP(cm_idxn) (29)

and subsequently decrypts the encrypted data for challenge M, at step 440, according to:

CMN=AEAD_decrypt(cm_keyn,encr_cmn) (30)

At this point, the user node is in possession of the M challenges whereas the authenticator nodes are in possession of the required responses to each of the M challenges. For each of the M different challenges, the user provides a proposed response, proposalM_N. For example, the user may be required for a given proposed response to submit a textual response to a question, e.g., where the challenge states “Mother's maiden name?”, the proposed response may be “Smith.” Alternatively, the challenge/proposed response scheme may require use of various types of media. In this case, the user may be required to select, from a plurality of images or sound clips presented in the challenge, a particular response that corresponds to an image/sound clip previously provided by the user. As an example, when the challenge was originally established by the user during an enrollment process, the user may be prompted to submit a non-personally-identifying image or sound clip such as an image of an object or favorite song known to the user, which image or sound clip is then preserved as the challenge response stored in the system nodes. Thereafter, when the challenge is presented to the user via the user node, the user must pick from among a plurality of similar images or sound clips in order to provide the proposed response.

Regardless, each proposalM_N is submitted to the relevant authenticators, authenticatorM_N. In turn, each authenticatorM_N checks proposalM_N against previously-obtained challenge response, respM_N, that it has on hand. Depending on the nature of the challenge and required response, the process of assessing the proposed response may be mediated through a processing device (such as a system node) or may require human assessment. For example, in the case where the nature of the response is a string of text or the like, assessment of the proposalM_N with respM_N may be automatically performed by each authenticatorM_N using known comparison techniques. Alternatively, as in the example where images or sound clips are employed (or even in the case of textual responses), a human associated with authenticatorM_N may be prompted to perform an assessment of proposalM_N against respM_N. e.g. by looking at the two side-by-side in the case of images or listening to both. The human then selects “Yes” indicating that they match, or “No” indicating they do not. If the human selects “Yes”, the authenticator node then releases its secret share to the user node. Alternatively, assessment by the human may result in a non-binary (yes/no) decision, as in the case where the user is asked to give a confidence score. For example, if proposalM_N is a current image of an object obtained by the user at the time of submitting proposalM_N (e.g., by taking a picture of the object with his/her smart phone) and respM_N is a previous image of that same object, the human performing the authentication may be asked to provide an indication of his/her degree of confidence that the images are based on the same object, e.g., “unsure,” “very sure,” “20% confident,” “95% confident,” etc. In this case, the determination whether to release the secret share is based on comparison of the confidence assessment with a threshold, e.g., the challenge is satisfied only when the expressed confidence level exceeds 75% confidence.

Additionally, as a matter of policy, defined when the secret shares were created, it is possible to use single or two-layer secret splitting. For example, the method described above relies on a single-layer of secret splitting, i.e., the secret data is split once into the secret shares. Alternatively, two-layer secret splitting would mean that the secret data is split into M shares, each of which is then likewise split into N shares per M challenges. This way, the requisite percentage needed per-challenge can be adequately enforced, e.g., 50% for a particularly complex challenge versus 90% for a less complex challenge. Further still, in the case where human-based confidence levels are employed, rather than binary decision, this process may require a further assessment based on the collective confidence levels. For example, release of secret shares occurs only when the average of all obtained confidence levels exceeds a given threshold.

While particular preferred embodiments have been shown and described, those skilled in the art will appreciate that changes and modifications may be made without departing from the instant teachings. It is therefore contemplated that any and all modifications, variations or equivalents of the above-described teachings fall within the scope of the basic underlying principles disclosed above and claimed herein.

What is claimed is:

1. A method for recovering secret data in a system comprising a user node and a plurality of system nodes, where the secret data is distributed as a plurality of secret shares among the plurality of system nodes and where knowledge of less than a first threshold number of the plurality of secret shares is insufficient to reconstruct the secret information, the method comprising:
sending, by the user node to the plurality of system nodes, a request comprising a seed value;
receiving, by the user node from each system node of at least a first subset of the plurality of system nodes in response to the request, a reply comprising a cryptographic hash value based on the seed value and information unique to the system node, thereby providing a plurality of cryptographic hash values uniquely corresponding to the first subset of the plurality of system nodes;
generating, by the user node, an ordered listing of the first subset of the plurality of system nodes according to the corresponding plurality of cryptographic hash values;
selecting, by the user node, a second subset of the first subset of the plurality of system nodes based on the ordered listing; and
recovering, by the user node, the secret data based on the secret shares possessed by at least some of the second subset of the plurality of system nodes.

2. The method of claim 1, wherein the seed value is a random number generated by the user node.

3. The method of claim 1, wherein the seed value is deterministically generated by the user node based on state information of the system not under the control of the user node or a user of the user node.

4. The method of claim 1, wherein the information unique to each system node comprises a public key for the system node.

5. The method of claim 1, further comprising:
receiving, by the user node from a system node of the plurality of system nodes, a rate limiting challenge comprising parameters for performing a computation by the user node and a required result to be determined through performance of the computation;
performing, by the user node, the computation based on the parameters and a user-node-determined value until the required result is achieved; and
sending, by the user node to the system node, the required result.

6. The method of claim 1, wherein generating the ordered listing further comprises sorting the cryptographic hash values in ascending or descending order.

7. The method of claim 1, wherein recovering the secret information based on the secret shares possessed by the second subset of the plurality of system nodes further comprises:
requesting, by the user node, to receive at least one identity verification challenge from the second subset of the plurality of system nodes;
receiving, by the user node from the second subset of the plurality of system nodes, the at least one identity verification challenge, where each of the at least one identity verification challenge requires performance by a user of the user node to provide at least one response to the at least one identity verification challenge;
sending, by the user node, the at least one response to the second subset of the plurality of system nodes;
receiving, by the user node from at least some of the second subset of the plurality of system nodes, at least some of the plurality of secret shares to provide received secret shares; and
reconstructing, by the user node, the secret data based on the received secret shares when a total number of received secret shares equals or exceeds the first threshold number.

8. The method of claim 7, wherein requesting to receive the at least one challenge further comprises:
requesting, by the user node, to receive challenge configuration data from the second subset of the plurality of system nodes, where the challenge configuration data is distributed as a plurality of challenge configuration shares among the plurality of system nodes and where knowledge of less than a second threshold number of the plurality of challenge configuration shares is insufficient to reconstruct the challenge configuration data;
receiving, by the user node from at least some of the second subset of the plurality of system nodes, at least some of the plurality of challenge configuration shares to provide received challenge configuration shares; and
reconstructing, by the user node, the challenge configuration data based on the received challenge configuration shares when a total number of received challenge configuration shares equals or exceeds the second threshold number,
wherein requesting to receive the at least one challenge is based on the reconstructed challenge configuration data.

9. The method of claim 8, wherein requesting to receive the challenge configuration data further comprises:
requesting, by the user node, to receive configuration prekey data from the second subset of the plurality of system nodes, where the configuration prekey data is distributed as a plurality of configuration prekey shares among the plurality of system nodes and where knowledge of less than a third threshold number of the plurality of configuration prekey shares is insufficient to reconstruct the configuration prekey data;
receiving, by the user node from at least some of the second subset of the plurality of system nodes, at least some of the plurality of configuration prekey shares to provide received configuration prekey shares; and
reconstructing, by the user node, the configuration prekey data based on the received configuration prekey shares when a total number of received configuration prekey shares equals or exceeds the third threshold number,
wherein requesting to receive the challenge configuration data is based on the reconstructed configuration prekey data.

10. A user node for recovering secret data in a system comprising the user node and a plurality of system nodes, where the secret data is distributed as a plurality of secret shares among the plurality of system nodes and where knowledge of less than a first threshold number of the plurality of secret shares is insufficient to reconstruct the secret information, the user node comprising:
a processor;
a storage device, operatively connected to the processor, having stored thereon executable instructions that, when executed by the processor, cause the processor to:
send, to the plurality of system nodes, a request comprising a seed value;
receive, from each system node of at least a first subset of the plurality of system nodes in response to the request, a reply comprising a cryptographic hash value based on the seed value and information unique to the system node, thereby providing a plurality of cryptographic hash values uniquely corresponding to the first subset of the plurality of system nodes;
generate an ordered listing of the first subset of the plurality of system nodes according to the corresponding plurality of cryptographic hash values;
select a second subset of the first subset of the plurality of system nodes based on the ordered listing; and
recover the secret data based on the secret shares possessed by at least some of the second subset of the plurality of system nodes.

11. The user node of claim 10, wherein those executable instructions that cause the processor to send the seed value are further operative to generate a random number as the seed value.

12. The user node of claim 10, wherein those executable instructions that cause the processor to send the seed value are further operative to deterministically generate the seed value based on state information of the system not under the control of the user node or a user of the user node.

13. The user node of claim 10, wherein the information unique to each system node comprises a public key for the system node.

14. The user node of claim 10, further comprising executable instructions that, when executed by the processor, cause the processor to:
receive, from a system node of the plurality of system nodes, a rate limiting challenge comprising parameters for performing a computation and a required result to be determined through performance of the computation;
perform the computation based on the parameters and a user-node-determined value until the required result is achieved; and
send, to the system node, the required result.

15. The user node of claim 10, wherein those executable instructions that cause the processor to generate the ordered listing are further operative to sort the cryptographic hash values in ascending or descending order.

16. The user node of claim 10, wherein those executable instructions that cause the processor to recover the secret information based on the secret shares possessed by the second subset of the plurality of system nodes are further operative to:
request to receive at least one identity verification challenge from the second subset of the plurality of system nodes;
receive, from the second subset of the plurality of system nodes, the at least one identity verification challenge, where each of the at least one identity verification challenge requires performance by a user of the user node to provide at least one response to the at least one identity verification challenge;
send the at least one response to the second subset of the plurality of system nodes;
receive, from at least some of the second subset of the plurality of system nodes, at least some of the plurality of secret shares to provide received secret shares; and
reconstruct the secret data based on the received secret shares when a total number of received secret shares equals or exceeds the first threshold number.

17. The user node of claim 16, wherein those executable instructions that cause the processor to request to receive the at least one challenge are further operative to:
request to receive challenge configuration data from the second subset of the plurality of system nodes, where the challenge configuration data is distributed as a plurality of challenge configuration shares among the plurality of system nodes and where knowledge of less than a second threshold number of the plurality of challenge configuration shares is insufficient to reconstruct the challenge configuration data;
receive, from at least some of the second subset of the plurality of system nodes, at least some of the plurality of challenge configuration shares to provide received challenge configuration shares; and
reconstruct the challenge configuration data based on the received challenge configuration shares when a total number of received challenge configuration shares equals or exceeds the second threshold number,
wherein the request to receive the at least one challenge is based on the reconstructed challenge configuration data.

18. The user node of claim 17, wherein those executable instructions that cause the processor to request to receive the challenge configuration data are further operative to:
request to receive configuration prekey data from the second subset of the plurality of system nodes, where the configuration prekey data is distributed as a plurality of configuration prekey shares among the plurality of system nodes and where knowledge of less than a third threshold number of the plurality of configuration prekey shares is insufficient to reconstruct the configuration prekey data;
receive, from at least some of the second subset of the plurality of system nodes, at least some of the plurality of configuration prekey shares to provide received configuration prekey shares; and
reconstruct the configuration prekey data based on the received configuration prekey shares when a total number of received configuration prekey shares equals or exceeds the third threshold number,
wherein the request to receive the challenge configuration data is based on the reconstructed configuration prekey data.
